(19) United States
(12) Patent Application Publication
(10) Pub. No.: US 2014/0155148 A1
(43) Pub. Date: Jun. 5, 2014

(54) PROCESS FOR TRACKING GREENHOUSE GAS EMISSIONS/CARBON REDUCTIONS AND OTHER ENVIRONMENTAL CREDITS IN OPEN AND CLOSED TRADING SYSTEMS UTILIZING A MOBILE APPLICATION AND ACCOMPANYING CLIMATE CHANGE VIDEO GAME

(71) Applicants: Jerald Wrightsil, Austin, TX (US); Melanie Barnes, Austin, TX (US); Rebecca Jo Reser, Austin, TX (US)

(72) Inventors: Jerald Wrightsil, Austin, TX (US); Melanie Barnes, Austin, TX (US); Rebecca Jo Reser, Austin, TX (US)

(73) Assignee: TEXAS CLIMATE AND CARBON EXCHANGE LLC, Austin, TX (US)

(21) Appl. No.: 14/232,614

(22) PCT Filed: Jul. 16, 2012
(86) PCT No.: PCT/US12/46880

§ 371 Date: Jan. 13, 2014

Related U.S. Application Data
(60) Provisional application No. 61/507,796, filed on Jul. 14, 2011.
(60) Provisional application No. 61/621,231, filed on Apr. 6, 2012.

(51) Int. Cl. G06Q 40/04; G06Q 30/00

(52) U.S. Cl. CPC G06Q 40/04; G06Q 30/018
USPC 463/25; 705/37; 705/317

(57) ABSTRACT

A mobile application for use in facilitating environmental credits has been developed for individual as well as corporate and municipality use. The downloadable application can be used to track a user's carbon footprint and possible reductions in carbon use through purchasing green products and other methods of carbon savings. The closed loop feature allows the user to return the carbon credits to the manufacturer of the green product. Although carbon credits are used in the examples, the invention can be used for any type of environmental credit or reduction in monitored substance. Also, the invention is flexible in its application and can be used to track carbon savings for event travel. The use of the mobile application is unlimited in geographic reach.

### PRIOR RELATED APPLICATIONS

The application claims priority to U.S. Ser. No. 61/621,231, filed Apr. 6, 2012 and 61/507,796, filed Jul. 14, 2011 and expressly incorporated by reference herein in their entirety for all purposes.

### FEDERALLY SPONSORED RESEARCH STATEMENT

Not applicable.

### REFERENCE TO MICROFICHE APPENDIX

Not applicable.

### FIELD OF THE INVENTION

The field of the invention relates to tracking environmental credits and offsets via a smart phone mobile application or other method for access to the Internet, enabling individuals and organizations to participate in the trading process. More specifically, a business process for establishing and maintaining an exchange network of individuals, industries, business owners, utilities and other entities allowing users to calculate, certify, store, and trade greenhouse gas/carbon emissions reductions and other environmental credits, including water conservation credits or aqua credits, which can be accessed by a mobile application or other means via the Internet.

A business process to link individual users and consumers of a particular product or service to the manufacturer or supplier of that particular product or service, allowing calculation, storage, certification and trading of greenhouse gas/carbon emissions reductions and other environmental credits, including water conservation or aqua credits, created by the individual's deployment of the qualifying product or service, back to the product manufacturer or supplier in exchange for compensation and allowing the manufacturer to aggregate its customers' purchased credits and to apply them to its own mandatory or voluntary emissions reductions goals.

A business process for calculating the carbon offsetting activities of consumers associated with attending an event or travel to another location, tracking the activities engaged in by those consumers, certifying those carbon savings, rewarding each consumer based on the total carbon offsets generated by their activities, aggregating total attendee credits, transferring those credits to the major event sponsor, and applying those attendee credits to offset the carbon footprint of the major event.

A business process for affiliating with the carbon credits network a simulated-city climate change online video game with capability for embedded real time energy management and carbon credit tracking, certification and trading.

### BACKGROUND OF THE INVENTION

This invention is a greenhouse gas emissions reductions and other environmental offsets calculation, storage, and trading system to be used by corporations, utilities, cities, and individuals. The proposed mobile application (sometimes “APP”) allows easy access to this trading network. This exchange model rewards individuals, utilities, companies and cities for reducing their carbon emissions, while benefiting corporations that embrace their corporate environmental responsibility in part by purchasing credits through this program.

Due to rising anxiety over global warming, and because of greater carbon emissions in the atmosphere, local and national administrations as well as worldwide organizations have been searching for effective solutions to the problem of greenhouse gas emissions. Among several strategies for resolving this problem, trading of large scale renewable energy credits and carbon offsets has been widely accepted. What has been missing from these programs is a mechanism for tracking, verifying, trading and rewarding individual consumers' reductions.

The voluntary carbon offset trading concept gives corporations, other entities and individuals incentives to reduce their carbon footprints either directly by carbon reduction activities or indirectly by purchasing carbon credits. The process provides a means for individuals not only to quantify the true impact of their daily activity's effect on our climate, but also to encourage the adoption of more environmentally friendly ways of living and doing business. As more and more individuals and companies opt for this approach, total greenhouse gas emissions levels around the world will decrease, reducing overall greenhouse gas levels and protecting the environment. Notwithstanding cap and trade legislation that may exist in certain markets, competitive company branding in this era of social network marketing promotes environmentally friendly corporate policies in every business location. This individual voluntary program can be referred to as micro, mini, or nano cap and trade; or alternatively micro, mini, or nano trade. The process of this invention is complementary to the cap and trade legislative initiatives and the existing voluntary carbon market.

A carbon credit is a standard unit consisting of a reduction of one metric ton of carbon. The world market for carbon in 2011 was a total of $176 billion, with an expected market value of $3 trillion by 2020.

Carbon offsets are generated by deploying qualifying devices or practices, which are quantified and then certified by one of several nonprofit carbon registries and then listed on that registry. The credits may next be posted for sale on an exchange, which matches the particular kind of credit with a buyer, completes the transaction, and arranges the retirement of the credit if requested. The same process would be followed for other environmental credits, including aqua credits. Certification of carbon credits requires that the qualifying green purchase or carbon reducing activity must be (1) real, (2) measurable, (3) permanent, and (4) additional. Additionality means that the green purchase or activity would not have taken place but for the credit as an incentive. The business process described here will reward individual purchases and activities which meet certification standards.

The business process includes access by mobile application, because it creates maximum ease and access for young consumers and others who are most likely to embrace behavior change. Further, many studies have shown that gaming is a very effective learning activity for this demographic and can incorporate important real time concepts in simulated city games, which translate directly to real time applications. Therefore, an affiliated climate change online simulated city video game allowing virtual and real time carbon credit creation and trading is included in this invention.

Educating and rewarding those individuals who are users of the process with credits or points for reducing their carbon footprints incentivizes everyone to participate, further slowing climate change and reducing pollution globally. As cities around the world struggle to create sustainable environments for their residents, they are on the front lines of environmental conservation. If city residents can be rewarded, via sustainable incentive programs, for adhering to municipal carbon reduction goals and policies, these programs can allow each resident to have a positive impact on the global carbon footprint.

### BRIEF DESCRIPTION OF THE DRAWINGS

FIG. 1 is a schematic illustrating the existing carbon trading model.

FIG. 2 is a flow chart demonstrating an embodiment of the closed loop model of the process.

FIG. 3 is a drawing highlighting features of the invention, including multiple participants in different countries and municipalities, and utilizing the mobile application to connect to the carbon trading system that can be applied to any environmental credits.

FIG. 4 is a model of a trading scheme allowing creation and trading of credits to offset carbon generated attendance t to an event.

FIG. 5 is a diagram of the simulated city climate change online video game.

### DESCRIPTION OF EMBODIMENTS OF THE INVENTION

The following are illustrative process steps for utilization of the present invention.

Step 1:

Mobile application can be built on an open source or other platform or code, with full banking functionality to be written in code that allows the users or consumers to utilize their credit cards for purchases, trades, and barters within the application. Although the example below is directed specifically to carbon credits for illustration purposes, the invention can be used for any environmental credits.

Mobile application will be comprised of three (3) segments:

(1) Access to a registry that includes a database for all participants (individual users or consumers and corporate).

(2) Exchange platform for credit exchange that will be used for trading of carbon (or other environmental) offsets.

(3) Settlement mechanism (asset management entity).

Step 2:

User is allowed to download the mobile application for example, by clicking on the download icon on user's mobile telecommunication device, or by double clicking on the download icon on user's laptop/personal computer or other equivalent method to become a participant in the registry.

Upon agreeing to terms of usage, the user is transferred to the user interface page of the application, on which the user can review the purpose of interaction on the application.

Carbon Calculator: This function allows the user to calculate the user's carbon footprint based upon lifestyle, purchases, means of travel, usage of energy, and other factors.

Carbon Trading: This function allows the user to trade user's certified credits on the credit exchange.

Charity: This function allows the user to donate funds or credits to any designated organization or project for use within the exchange.

Step 3:

Carbon calculator is a program that allows the user to input real time data that is cross referenced with a global carbon standard and then to calculate the data's impact on the environment, thus giving the user a data format of its carbon footprint. This data is used to determine whether or not the user's purchasing habit or lifestyle is having a positive impact on the environment, or whether these decisions should be evaluated further in hopes of making a more strategic, positive impact on the earth's environment.

Step 4:

All opted-in users will access the carbon trading platform. Users who possess credits will have earned these credits by either purchases, green practices, or from previous trades. A credit will be assigned a certain numerical value within the registry and exchange based on the standard value of a carbon credit or percentage thereof. Once that value is assigned, the credit is listed within the user's account in the exchange, or is assigned to a pool within the exchange established for microcredits and microtraders. The user can access the exchange via the mobile application or from a laptop/desktop computer or other device by means of an assigned “user id” and “user password” that are unique to each user within the registry or other method unique to the user.

Upon access to the unique account within the exchange, the user will have a full historical record of the account activity, performance, spending habits, and credit value.

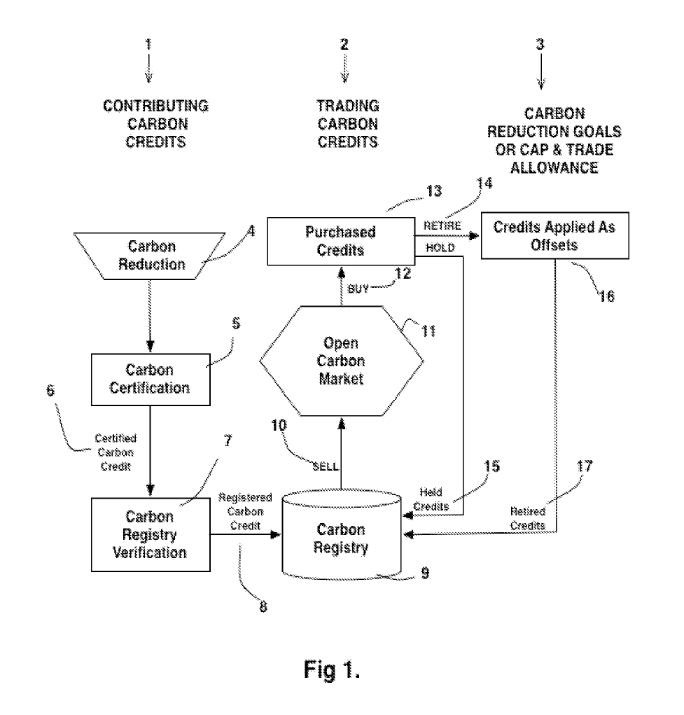

FIG. 1 illustrates the primary functions of the existing carbon offsets market. Generally, Step 1 begins with Contributing Carbon Credits, continues with Step 2 of Trading Carbon Credits, and then applies those credits to Carbon Reduction Goals or Cap & Trade Allowance. In more detail, the process is initiated by a qualifying Carbon Reduction 4. That reduction is processed in the Step 5 Carbon Certification, wherein a detailed study determines the amount of carbon being reduced by the green purchase or process, according to a specific registry-approved protocol. Each registry, whether for voluntary or compliance (Cap & Trade) markets has its own detailed protocols for certification of carbon credits. This results in a Step 6 Certified Carbon Credit, qualified for the registry's specific carbon market. That Certified Carbon Credit in Step 7 undergoes Carbon Registry Verification, similar to a third party audit to determine that the credit actually meets the registry's requirements. Step 8 represents the Registered Carbon Credit, which is then listed on the Step 9 Carbon Registry.

Step 10 denotes a Sell of the Credits through the Step 11 Open Carbon Market. In Step 12, a Buy of the credits yields Step 13 Purchased Credits, which the purchaser can Retire, shown as Step 14. The purchaser may instead opt to Hold Credits, indicated by Step 15, for future use or resale. When the purchaser retires the credits, it is as Credits Applied as Offsets, shown in Step 16, used to meet the individual, /manufacturer, /utility, or /business's voluntary carbon reduction goals or cap and trade allowance. Step 17 indicates that Retired Credits will be recorded by the exchange and the registry for the account of the purchaser so that the credits cannot be sold again.

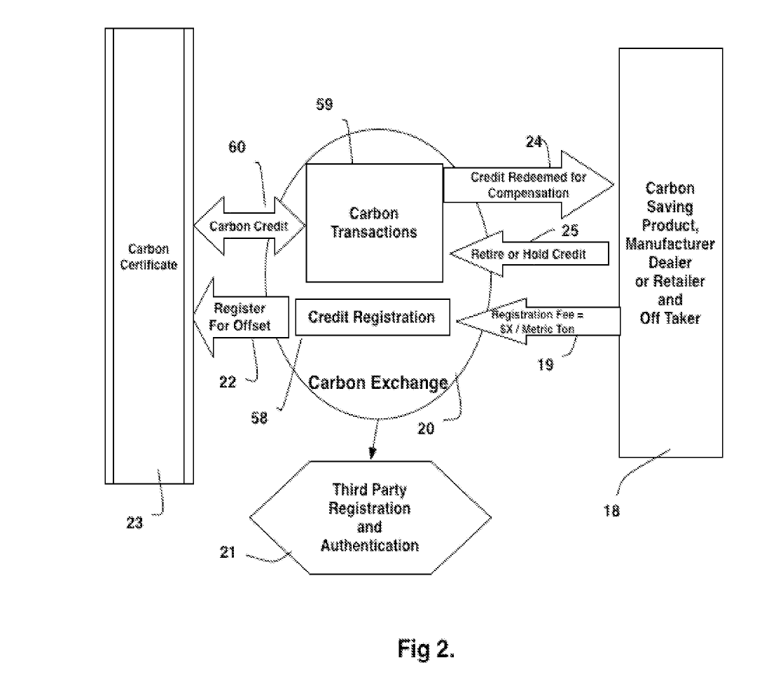

In contrast to the existing carbon trading scheme in FIG. 1, FIG. 2 depicts one example of the closed loop model, which is one embodiment of the present invention in which the credits created by the purchaser of a product or process are sold back to the manufacturer, dealer or retailer of that product or process. Numeral 18 illustrates the Carbon Saving Product Manufacturer, Dealer or Retailer, who will also be the Off Taker for the eventual credits. At numeral 19, the Manufacturer, Dealer, or Retailer applies with a Registration Fee for potential credits (Carbon Registration 58) to be created for its users or customers, illustrated as a Carbon Credit 60. That application is filed with the designated Carbon Exchange 20. In order to create valid credits for the Manufacturer, Dealer, or Retailer, there is a Third Party Registration Certification and Authentication entity 21 affiliated with the Carbon Exchange 20. The Manufacturer, Dealer, or Retailer Register for the Offset 22 by virtue of the customer's qualifying green purchase or process from the Manufacturer, Dealer, or Retailer, and the user is issued a Carbon Certificate 23.

Next, that Carbon Certificate 23 is traded in the Carbon Exchange 20 as part of a Carbon Transaction 59 and the Carbon Certificate upon trading is goes back into the Carbon Exchange where it can be redeemed. In the process of transfer of the Carbon Credit via the Carbon Exchange to the Manufacturer, Dealer, or Retailer, the user or customer is compensated financially or otherwise at 24 upon redemption. (The user or customer is not shown in FIG. 2, only the transactions involving the user.) The Manufacturer, Dealer, or Retailer of the Carbon Saving Product is the Off Taker and compensates its customer for the Carbon Credits. Then the Manufacturer, Dealer, or Retailer of the Carbon Saving Product as Off Taker of the Carbon Credit holds or retires the credit as shown at 25 in connection with Carbon Exchange to comply with its sustainability goals or cap and trade requirements.

In order to complete the transaction, when a Manufacturer, Dealer, or Retailer purchases a user's credits, the settlement of the transaction can be finalized by the exchange as described below are:

Balancing the user's account (+ or −);

Transaction fee to be processed.

Transaction fees for trades that take place utilizing the mobile application will be in the form of a percentage of telecom charge that will be assessed by the carrier for each digital monetary transaction that transpires within the program. Telecom and asset management will charge the user (via user's telecommunications account or credit card entry) for the agreed upon fee that will be assessed to the user. Telecommunication fees will be divided among the entities that are participating within the system delivery. Those participants include: retail phone provider, credit exchange network, mobile applications host, financial services firm.

Transaction fees for mobile application use will be automatically deposited in each party's designated bank account for auditing by each participant at an agreed upon time. Percentages of each fee will be determined within the contractual determinations of all participating parties.

Each trade of an offset on the mobile application will incur a transaction fee determined by the dollar amount to be transferred via the mobile application. The base currency can be United States Dollars, but transactions may be processed in exchange transactions depending on each user's native currency, if desired. The transaction participants can share any fees associated with the settlement of currency arbitrage into US Dollars as well.

Users will have the ability to acquire additional credits via the network's trading mechanism, whereby each participating user can solicit credits from any other participant within the program. Participating users can be located within the exchange network worldwide. The soliciting user, via listing on the registry and further advertising using a social media page can make a respective bid/wager for purchasing the counterparts' existing credits. Listing of credits on the exchange can be known as “banking credits”. The exchange of these credits between users can be known as “trading credits”.

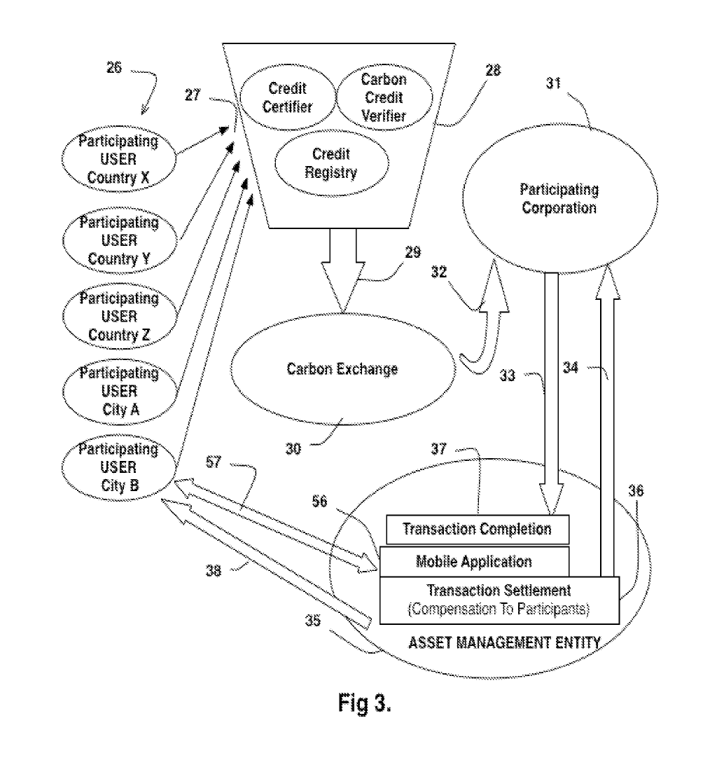

FIG. 3 illustrates one process of the invention. This begins with the Participating Users 26 who can be in different countries and/or cities who opt into the program. The Participating Users report the activity or purchase generating the carbon credit (or other environmental credit). FIG. 3 indicates the processing of the credit claim 27 through the Certifier, Registry, and Verifier generally shown at 28 that includes the Carbon Certifier, Carbon Credit Verifier and Carbon Credit Registry, as part of a pool of similar credits or microcredits created by users and customers. The resulting credits or pool of credits are transferred 29 and posted to a Carbon Exchange 30. This posting may be advertised through social media commerce as desired. Participating Corporation 31 (which can be a corporation or other entity in need of credits) transacts a purchase of the credits with a credit exchange illustrated in FIG. 3. The credits are transferred to the Participating Corporation 32 from Carbon Exchange 30. The payment by the Participating Corporation 33, and is finalization of the transaction 34 between the Participating Corporation and the Asset Management Entity 35. The Transaction Settlement 36 and the Transaction Completion 37 with the Participating Users is followed by a delivery of compensation to each Participating User 38. A major advantage within the invention is use of the Mobile Application 56, which allows participating users and participating corporations easy access to the entire carbon creation and trading process.

In an aspect, customers or users will be awarded credits to be traded on the credit exchange for environmental practices and purchases that contribute to the reduction of carbon emissions worldwide.

In a further aspect, cities, corporations, utilities and other entities that subscribe to the credit exchange will reward users and customers for reducing their carbon footprint by purchasing these individually created credits.

In another aspect, users and customers will be able to utilize this mobile application and the underlying program to determine the size and impact of their carbon footprints, learn how to earn credits by participating in emission reduction practices, make qualifying certified green purchases, and to sell their credits on the credit exchange.

Another aspect the mobile application and its underlying program can also create and store credits for non-carbon environmental conservation measures, such as water conservation credits (“Aqua Credits”) or any other monitored substance. These Aqua Credits can also be traded eventually on the credit exchange network by cities, corporations, utilities and individuals using this mobile application, in a manner similar to carbon reduction credits. The invention is adaptable to and includes environmental credits that can be generated by the use of any green product or process that a user can purchase to reduce carbon emissions, water pollution or controlling any monitored substance harmful to the environment. Also, green building processes and transportation methods can be included for generating credits. Virtually any green product or process is included in this invention.

Another unique aspect of the invention is its event model. This invention allows the creation of credits by attending events such as musical and theatrical performances, sports event, conferences, seminars or any other event requiring travel for qualifying transportation modes, which can be transferred to the event host for compensation and applied against the event's carbon footprint. Although this aspect of the invention is illustrated by event attendance, the invention is equally applicable to travel for work, vacation or any other destination travel such that the employer or hotel can qualify for credits.

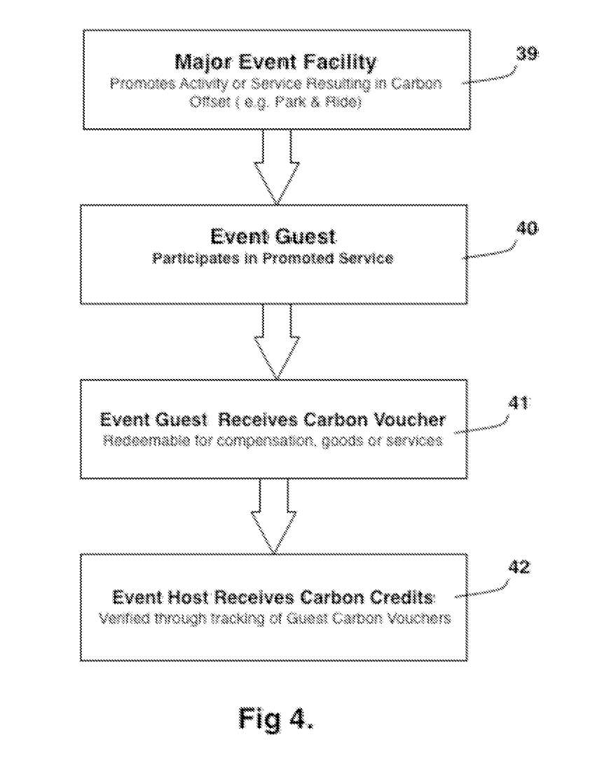

FIG. 4 illustrates the use of this invention for a major event with credits created by the guests at the event. Step 39 of the FIG. 4 illustrates the Major Event Facility, which promotes an activity or service resulting in the potential for creating carbon offsets by use of a park and ride facility, car pool, other mass transportation, hybrid vehicle use and other energy efficient methods of travel. Step 40 illustrates the Event Guest who participates in a promoted service to create carbon offsets of Step 39. This combination results in Step 41 with the creation and issuance of a carbon credit designated as a Carbon Voucher in 41. Next, the Carbon Credits based on the Carbon Vouchers are transferred by the Event Guest in Step 42 to the Event Host, who verifies the carbon credits, compensates the Event Guest, and then applies the Carbon Credit to the Major Event's carbon footprint. Though denoted as a Major Event, this invention can be deployed for events of any size that attendees use various transportation modes as explanation above.

A unique aspect of the invention is the inclusion of an accompanying online simulated city video game involving climate change and the management of carbon footprints and other environmental attributes.

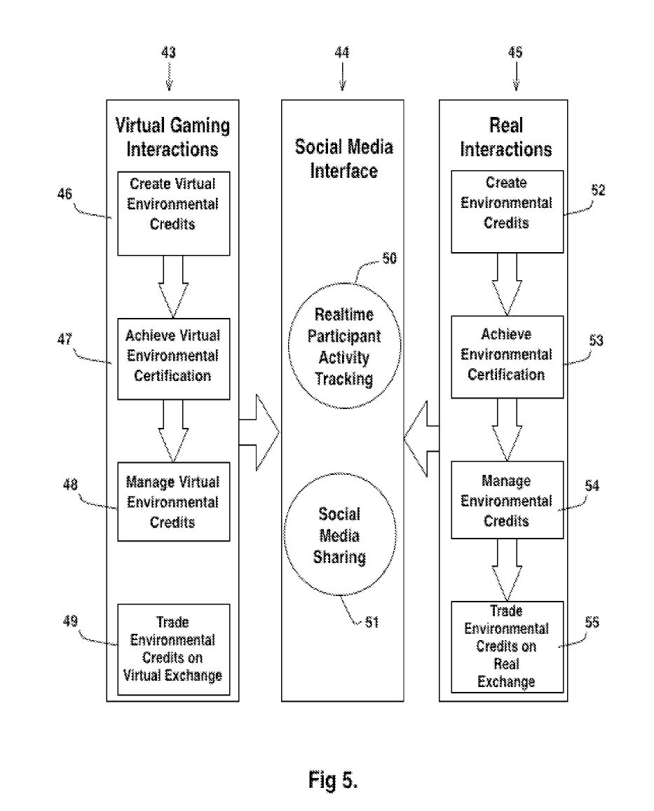

FIG. 5 depicts the online simulated-city video game as another alternative embodiment of the present invention. This flow chart in FIG. 5 shows in Step 43 the Virtual Gaming Interactions column, in Step 44 the Social Media Interface, and in Step 45 Real Interactions. In the Virtual Gaming Interactions column, Step 46 reflects in game ability to Create Virtual Environmental Credits. In Step 47, those credits Achieve Virtual Environmental Certification. The user can Manage Virtual Environmental Credits as Step 48, and may elect to Trade Environmental Credits on the Virtual Exchange represented in Step 49. The Social Media Interface allows important functions, including Real Time Participant Activity Tracking as Step 50, and Social Media Sharing about these activities as Step 51.

The game's use in Real Interactions is illustrated in Step 52 with Creation of the Environmental Credits. Those credits are processed in the Achieve Environmental Certification Step 53. Next, the user can Manage the Credits as Step 54, and may elect to Trade Environmental Credits on a Real Exchange per Step 58 to realize compensation for qualifying green purchases or practices. Individually generated credits may be aggregated into a pooled account of small credit (micro credit or nano credit) of the same or similar type to constitute sufficient volume for sale to a purchaser that needs environmental off sets.

The credit exchange network, and its operational partners can share in income generated by arbitrage of transactions including rebate transactions, foreign currency exchange transaction fees, credit redemptions, and sale or shipping of corporate merchandise and services.

Renewable energy credits and carbon offsets can be transferred to utilities and corporations needing to acquire them for reductions against emissions.

In a unique aspect, eenvironmental nonprofits who undertake qualifying green projects can be funded by donations from individuals, corporations, utilities, cities, and other entities in exchange for credits resulting from those certified projects.

An additional aspect of the invention is that cities, states, utilities and nonprofits can use this program as an instructional tool to educate individuals via the mobile application about conserving energy and directly reducing their carbon footprints.

In an important aspect, universities and nonprofits can conduct research projects to develop practices, products, and services that earn credits. Additionally, educational curricula and careers can be developed to further these carbon reduction goals. Links on the mobile application can take users to these educational sites.

An aspect of the invention is its inclusion of a hotline for information on the application and a webpage on the exchange website offering information on carbon footprints, carbon credits, and carbon trading.

Advertisements from corporate subscribers of their carbon reduction products and other environmental products on the mobile application can include links to their marketing websites.

In other aspects, pilot projects can be developed and operated to prove the viability of a closed loop trading program between the manufacturers and their customers to aggregate the customers' carbon credits for the benefit of the manufacturers, as well as pilots for major event carbon reduction programs and pilots for specific green product or green process deployments.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims.

1. A method of trading environmental credits comprising:
providing a downloadable application for trading environmental credits on a device capable of connecting to the Internet to a user;
calculating the user's environmental footprint to determine credits available for offset trading;
certifying the user's environmental credits,
forwarding the user's certified environmental credits to a central registry that compiles and stores environmental credits from individuals, corporations, municipalities, carbon reduction projects and other entities that have offsets for trading;
facilitating the trading of the certified environmental credits by users with credits with entities in need of offsets;
reconciling the exchange of environmental credits; and
compensating the user for the environmental credits.

2. A method of claim 1 wherein the environmental credits are selected from the group of carbon credits, aqua credits, monitored substances and mixtures thereof.

3. A method of claim 1 wherein the entities in need of offsets are selected form the group of companies, municipalities and countries.

4. A method of claim 1 wherein the exchange collects a transaction fee on the trading of the environmental credits.

5. A method of claim 1 further comprising
locating via the application a manufacturer, dealer or retailer that has registered an authenticated green product or process with an exchange;
purchasing the green product or process by the user;
using the green product by the user to create certified environmental credits;
registering the certified environmental credits created by the user; and
trading the certified credits back to the manufacturer, dealer or retailer in a closed loop system.

6. A method of claim 1 wherein the user creates additional environmental credits by using the downloadable application to calculate the credits through use of green products and building processes.

7. A method of claim 1 where in the entities in need of environmental offsets may obtain credits through trading with the exchange.

8. A method to create carbon credits in connection with an event via the mobile application comprising
identifying an event that requires travel to attend;
further identifying the energy efficient travel methods;
establishing carbon credits for the energy efficient travel methods; and
issuing carbon vouchers to those users taking energy efficient travel methods

9. A method of claim 8 wherein the event organizer promotes the energy efficient travel and receives the carbon vouchers from the users in return for compensation.

10. A method of claim 8 wherein the event is selected from the group of musical and theatrical performances, sports event, conferences, seminars, work locations or travel destinations.

11. A method of claim 8 wherein the energy efficient travel is selected from the group of park and ride facility, car pool, mass transportation and hybrid vehicle use.

12. A game for simulating positive environmental intervention comprising the steps of:
providing a downloadable game on a device capable of connecting the Internet to a user;
educating the player in the urgency of climate change;
calculating the player's environmental footprint via input provided by the player; and
notifying the player of possible virtual credits available for virtual offset trading;

13. A game of claim 12 wherein the game simulates a virtual city and the player may input environmental data to determine the virtual city change in credits.

14. A game of claim 12 comprising the additional steps of
offering the player the option to conduct real time energy management through the game; and
providing information and connection to the exchange to allow for sale of the real time credits created by the player.

15. A game of claim 12 wherein individually generated credits are aggregated into a pooled account of small credit (micro credit or nano credit) sellers of the same or similar type to constitute sufficient volume for sale to a purchaser.

16. A game of claim 12 wherein the information on the credit trading is transmitted via social media.
